(19) United States
(12) Patent Application Publication
(10) Pub. No.: US 2022/0309891 A1
(43) Pub. Date: Sep. 29, 2022

(54) Tracking And Alarm System

(71) Applicant: Dexter Fass, Boulder City, NV (US)

(72) Inventor: Dexter Fass, Boulder City, NV (US)

(21) Appl. No.: 17/701,916

(22) Filed: Mar. 23, 2022

Related U.S. Application Data
(60) Provisional application No. 63/166,909, filed on Mar. 26, 2021.

(51) Int. Cl. G08B 13/22; H04B 1/3827

(52) U.S. Cl. CPC G08B 13/22; H04B 1/385

(57) ABSTRACT

A tracking and alarm system, including at least one wearable tracking device to be worn around at least a portion of a body of a user, at least one primary receiver connected to the at least one wearable tracking device to receive a location of the at least one wearable tracking device based on a GPS signal, and perform at least one of emit an alarm sound and display an alarm warning thereon, and at least one mobile device connected to the at least one wearable tracking device to receive a location of the at least one wearable tracking device based on a GPS signal, and perform at least one of emit an alarm sound and display an alarm warning thereon.

### CROSS-REFERENCE TO RELATED APPLICATIONS

This application claims priority under 35 USC § 120 from U.S. Provisional Application No. 63/166,909, entitled “Tracking and Alarm System,” which was filed on Mar. 26, 2021, in the United States Patent and Trademark Office, the disclosure of which is incorporated herein in its entirety by reference.

### BACKGROUND

### 1. Field

The present general inventive concept relates generally to a tracking system, and particularly, to a tracking and alarm system.

### 2. Description of the Related Art

Amusement parks are one of the best pastime activities for families. However, amusement parks are also one of the best locations for children to get lost as it is very easy for a child to stray in such a saturated space. Although most occurrences end with the child being found within a few minutes, for parents and/or caregivers, there is nothing scarier than losing the child and the potential dangers associated with kidnapping.

Moreover, the parent and/or the caregiver can use a leash to keep the child within a fixed distance. Yet, the leash is prone to breaking and is not convenient for extended periods of use.

Therefore, there is a need for a tracking and alarm system that alerts the parent and/or the caregiver of the child's location, but also prevents removal thereof.

### SUMMARY

The present general inventive concept provides a tracking and alarm system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tracking and alarm system, including at least one wearable tracking device to be worn around at least a portion of a body of a user, at least one primary receiver connected to the at least one wearable tracking device to receive a location of the at least one wearable tracking device based on a GPS signal, and perform at least one of emit an alarm sound and display an alarm warning thereon, and at least one mobile device connected to the at least one wearable tracking device to receive a location of the at least one wearable tracking device based on a GPS signal, and perform at least one of emit an alarm sound and display an alarm warning thereon.

The at least one wearable tracking device may include a tracking body to send the GPS signal therefrom, a first strap disposed at a first end on at least a portion of a first side of the tracking body, a second strap disposed at a first end on at least a portion of a second side of the tracking body, a buckle disposed on at least a portion of a second end of the first strap, and a connecting portion disposed on at least a portion of a second end of the second strap to detachably connect to the buckle.

The at least one wearable tracking device may further include an RFID lock disposed within at least a portion of the buckle to prevent the connecting portion from detaching from the buckle.

The tracking and alarm system may further include at least one RFID reader to connect to the RFID lock to unbind the connecting portion from the buckle, such that the buckle and the connecting portion are unlocked.

The tracking body may determine at least one of a tamper of the buckle and an attempted tamper of the buckle in response to detecting at least one of the buckle being moved away from and attempted to be moved away from the connecting portion, respectively.

The tracking body may send at least one of an amber alert and a silver alert to the at least one primary receiver and the at least one mobile device in response to detecting at least one of a tamper of the buckle and an attempted tamper of the buckle.

The at least one primary receiver and the at least one mobile device may emit the alarm sound in response to a tampering of the at least one wearable tracking device.

The at least one primary receiver and the at least one mobile device may display the alarm warning in response to an attempted tampering of the at least one wearable tracking device.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of a tracking and alarm system, according to an exemplary embodiment of the present general inventive concept; and

FIG. 2 illustrates a zoomed in view of an RFID lock as disposed within a buckle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Tracking and Alarm System 100
Wearable Tracking Device 110
Tracking Body 111
Display Unit 111a
Input Unit 111b
Processing Unit 111c
Communication Unit 111d
Storage Unit 111e
First Strap 112
Second Strap 113
Buckle 114
Connecting Portion 115
Radio Frequency Identification (RFID) Lock 116
Primary Receiver 120
Receiver Body 121
Display Unit 122
Speaker 123
Control Buttons 124
Mobile Device 130
Input Unit 131
Display Unit 132
Processing Unit 133
Communication Unit 134
Storage Unit 135
Radio Frequency Identification (RFID) Reader 140

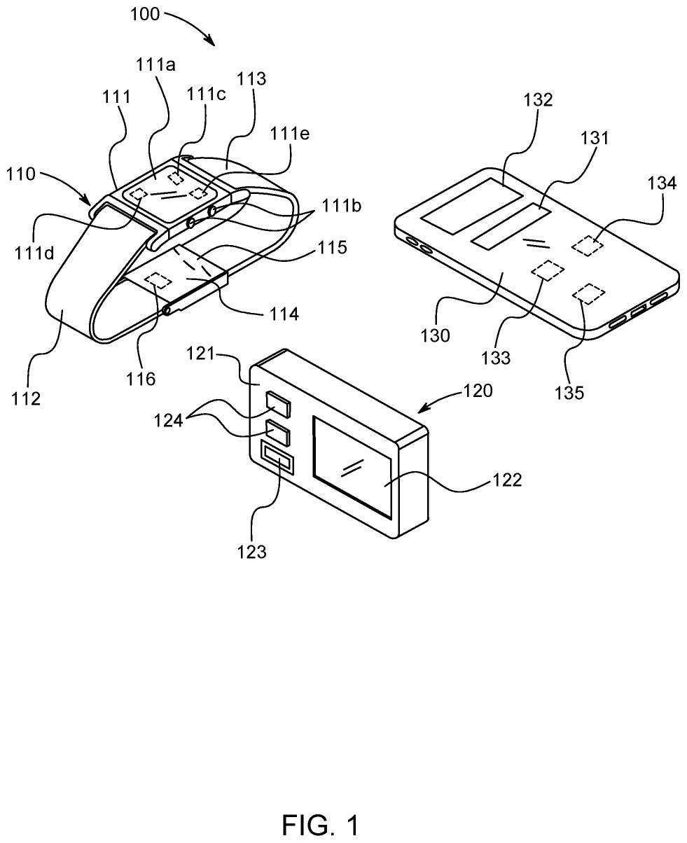

FIG. 1 illustrates a perspective view of a tracking and alarm system 100, according to an exemplary embodiment of the present general inventive concept.

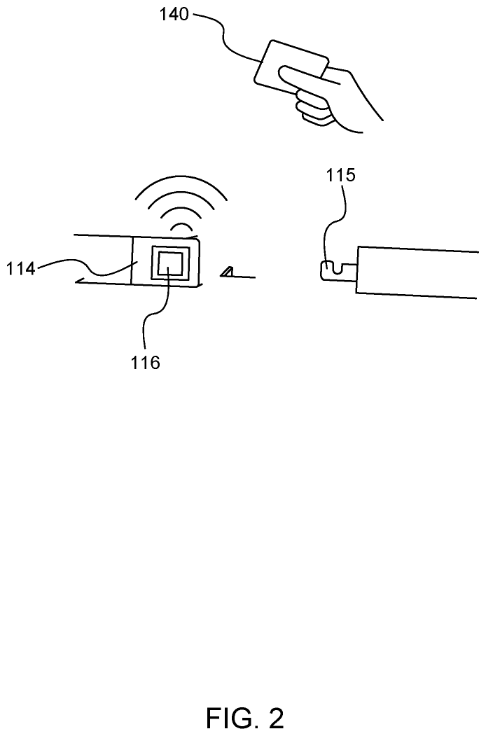

FIG. 2 illustrates a zoomed in view of an RFID lock 116 as disposed within a buckle 114, according to an exemplary embodiment of the present general inventive concept.

The tracking and alarm system 100 may be constructed from at least one of metal, plastic, wood, glass, and rubber, etc., but is not limited thereto.

The tracking and alarm system 100 may include at least one wearable tracking device 110, at least one primary receiver 120, at least one mobile device 130, and at least one radio frequency identification (RFID) reader 140, but is not limited thereto.

Referring to FIG. 1, the at least one wearable tracking device 110 is illustrated to be a watch. However, the at least one wearable tracking device 110 may be a necklace, a bracelet, a ring, a strap, a headband, or any other type of wearable accessory known to one of ordinary skill in the art, but is not limited thereto.

The at least one wearable tracking device 110 may include a tracking body 111, a first strap 112, a second strap 113, a buckle 114, a connecting portion 115, and an RFID lock 116, but is not limited thereto.

The tracking body 111 may have any predetermined size. For example, the tracking body 111 may be designed to fit a child, an adult, and/or universally sized (i.e. one-size fits all).

The tracking body 111 may include a display unit 111a, an input unit 111b, a processing unit 111c, a communication unit 111d, and a storage unit 111e, but is not limited thereto.

The display unit 111a may include a plasma screen, an LCD screen, a light emitting diode (LED) screen, an organic LED (OLED) screen, a computer monitor, a hologram output unit, a sound outputting unit, or any other type of device that visually or aurally displays data.

The input unit 111b may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

Also, the display unit 111a may be combined with the input unit 111b to be a touch-screen.

The processing unit 111c (or central processing unit, CPU) may include electronic circuitry to carry out instructions of a computer program by performing basic arithmetic, logical, control and input/output (I/O) operations specified by the instructions. The processing unit 111c may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 111c may also include a microprocessor and a microcontroller.

The communication unit 111d may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 111e may include a random access memory (RAM), a read-only memory (ROM), a hard disk, a flash drive, a database connected to the Internet, cloud-based storage, Internet-based storage, or any other type of storage unit.

The processing unit 111c may access the Internet via the communication unit 111d to allow a user to access a website, and/or may allow a mobile application and/or the software application to be executed using the processing unit 111c. For ease of description, the mobile and/or the software application will be hereinafter referred to as an app. The app may be downloaded from the Internet to be stored on the storage unit 111e.

The first strap 112 may be disposed at a first end on at least a portion of a first side of the tracking body 111. The second strap 113 may be disposed at a first end on at least a portion of a second side of the tracking body 111. The buckle 114 may be disposed on at least a portion of a second end of the first strap 112. The connecting portion 115 may be disposed on at least a portion of a second end of the second strap 113. The buckle 114 may receive the connecting portion 115 therein to connect to the connection portion 115. In other words, the connecting portion 115 may detachably connect to the buckle 114. As such, moving the buckle 114 away from the connecting portion 115 with respect to a lateral direction may detach (i.e. unhook) the buckle 114 from the connecting portion 115.

Furthermore, the RFID lock 116 may be disposed on and/or within at least a portion of the buckle 114. The RFID lock 116 may prevent the connecting portion 115 from detaching from the buckle 114. In other words, the RFID lock 116 may bind a hook portion of the connecting portion 115, such that the buckle 114 and/or the connecting portion 115 may be locked. Moreover, while the RFID lock 116 is bound within the connecting portion 115, moving the buckle 114 may not detach the buckle 114 from the connecting portion 115.

The processing unit 111c executing the app may determine a tamper of the buckle 114 and/or an attempted tamper of the buckle 114 in response to detecting the buckle 114 being moved away from and/or attempted to be moved away from the connecting portion 115. Additionally, the processing unit 111c executing the app may command the communication unit 111d to emit a GPS signal to identify a current location of the tracking body 111. Also, the processing unit 111c executing the app may command the communication unit 111d to alert at least one third party (e.g., a police department, a police officer, a security staff, an amusement park security staff), such as an amber alert and/or a silver alert.

The display unit 111a may display an alarm warning (e.g., words, color, flashing screen) based on the app in response to the tamper of the buckle 114 and/or the attempted tamper of the buckle 114. Alternatively, the display unit 111a may emit an alarm sound (e.g., a beep, a ring, a siren, a song) in response to the tamper of the buckle 114 and/or the attempted tamper of the buckle 114.

The at least one primary receiver 120 may include a receiver body 121, a display unit 122, a speaker 123, a plurality of control buttons 124, but is not limited thereto.

The receiver body 121 may have any predetermined size. For example, the receiver body 121 may be handheld.

The display unit 122 may include a plasma screen, an LCD screen, a light emitting diode (LED) screen, an organic LED (OLED) screen, a computer monitor, a hologram output unit, a sound outputting unit, or any other type of device that visually or aurally displays data.

Furthermore, the display unit 122 may include a communication unit.

The display unit 122 may be disposed on at least a portion of the receiver body 121. The display unit 122 may receive the GPS signal from the communication unit 111d. As such, the display unit 122 may display the current location of the tracking body 111 on a map. Also, the current location of the tracking body 111 may be a flashing dot. Moreover, the communication unit 111d may identify a heading on the map, such that the display unit 122 indicates a direction of travel of the tracking body 111.

Similar to the display unit 111a, the display unit 122 may display an alarm warning (e.g., words, color, flashing screen) in response to the tamper of the buckle 114 and/or the attempted tamper of the buckle 114.

The speaker 123 may be disposed on at least a portion of the receiver body 121. Additionally, the speaker 123 may emit an alarm sound (e.g., a beep, a ring, a siren, a song) in response to the tamper of the buckle 114 and/or the attempted tamper of the buckle 114. As such, the speaker 123 may notify the user that at least one unauthorized user is removing, has removed, is attempting to remove, and/or has attempted to remove the buckle 114 from the connecting portion 115.

Alternatively, the display unit 122 may display the alarm warning and/or the speaker 123 may emit the alarm sound in response to the at least one wearable tracking device 110 exceeding a predetermined distance away from the at least one primary receiver 120. In other words, the processing unit 111c executing the app may use a geofence based on settings determined by the user, such that the predetermined distance is set by the user (e.g., two feet, five feet, ten feet, fifteen feet, etc.).

The plurality of buttons 124 may be disposed on at least a portion of the receiver body 121. The plurality of buttons 124 may be used to operate the display unit 122 and/or the speaker 123, such as the type of alarm warning and/or the alarm sound used. Also, the plurality of buttons 124 may adjust the settings of the geofence.

The at least one mobile device 130 may include an input unit 131, a display unit 132, a processing unit 133, a communication unit 134, and a storage unit 135, but is not limited thereto.

Referring again to FIG. 1, the at least one mobile device 130 is illustrated to be a cell phone. However, the at least one mobile device 130 may be a tablet computer, a laptop computer, and a personal digital assistant (PDA).

The input unit 131 may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

The display unit 132 may include a plasma screen, an LCD screen, a light emitting diode (LED) screen, an organic LED (OLED) screen, a computer monitor, a hologram output unit, a sound outputting unit (e.g., a speaker), or any other type of device that visually or aurally displays data.

Also, the display unit 132 may be combined with the input unit 131 to be a touch-screen.

The processing unit 133 (or central processing unit, CPU) may include electronic circuitry to carry out instructions of a computer program by performing basic arithmetic, logical, control and input/output (I/O) operations specified by the instructions. The processing unit 133 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 133 may also include a microprocessor and a microcontroller.

The communication unit 134 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit 135 may include a random access memory (RAM), a read-only memory (ROM), a hard disk, a flash drive, a database connected to the Internet, cloud-based storage, Internet-based storage, or any other type of storage unit.

The at least one mobile device 130 may access the Internet via the communication unit 134 to allow the user to access a website, and/or may allow the app to be executed using the processing unit 133. The app may be downloaded from the Internet to be stored on the storage unit 135. In other words, the software application stored on the storage unit 111e may be the same as the app stored on the storage unit 135 of the at least one mobile device 130, such that the app facilitates communication between the at least one wearable tracking device 110 and/or the at least one mobile device 130.

Furthermore, the processing unit 133 executing the app may perform similar functions as the at least one primary receiver 120. More specifically, the processing unit 133 executing the app may receive the GPS signal from the communication unit 111d via the communication unit 134. As such, the display unit 132 may display the current location of the tracking body 111 on a map. Also, the current location of the tracking body 111 may be a flashing dot. Moreover, the communication unit 111d may identify a heading on the map, such that the display unit 132 indicates a direction of travel of the tracking body 111.

Similar to the display unit 111a, the display unit 132 may display an alarm warning (e.g., words, color, flashing screen) in response to the tamper of the buckle 114 and/or the attempted tamper of the buckle 114.

Also, the display unit 132 may emit an alarm sound (e.g., a beep, a ring, a siren, a song) in response to the tamper of the buckle 114 and/or the attempted tamper of the buckle 114. As such, the display unit 132 may notify the user that the at least one unauthorized user is removing, has removed, is attempting to remove, and/or has attempted to remove the buckle 114 from the connecting portion 115.

Alternatively, the display unit 132 may display the alarm warning and/or may emit the alarm sound in response to the at least one wearable tracking device 110 exceeding a predetermined distance away from the at least one mobile device 130. In other words, the processing unit 111c and/or the processing unit 133 executing the app may use a geofence based on settings determined by the user, such that the predetermined distance is set by the user (e.g., two feet, five feet, ten feet, fifteen feet, etc.).

The input unit 131 may be used to operate the display unit 132, such as the type of alarm warning and/or the alarm sound used. Also, the input unit 131 may adjust the settings of the geofence.

The at least one RFID reader 140 may be carried by the user, the amusement park security staff, the police, and/or any other authorized person. The at least one RFID reader 140 may connect to the RFID lock 116. As such, the RFID lock 116 may unbind the hook portion of the connecting portion 115, such that the buckle 114 and/or the connecting portion 115 may be unlocked. Moreover, while the RFID lock 116 is unbound from the connecting portion 115, moving the buckle 114 will detach the buckle 114 from the connecting portion 115. Accordingly, only the authorized persons may remove the at least one wearable tracking device 110 from a wearer (e.g., a child, an elderly person, a handicapped person, prison inmates, hospital patients, nursing homes, mental institutions).

Therefore, the tracking and alarm system 100 may prevent a child and/or other adult in need of assistance from leaving a proximity of a parent and/or a caregiver. Also, the tracking and alarm system 100 may alert the parent and/or the caregiver of the whereabouts of the at least one wearable tracking device 110 that is missing.

The present general inventive concept may include a tracking and alarm system 100, including at least one wearable tracking device 110 to be worn around at least a portion of a body of a user, at least one primary receiver 120 connected to the at least one wearable tracking device 110 to receive a location of the at least one wearable tracking device 110 based on a GPS signal, and perform at least one of emit an alarm sound and display an alarm warning thereon, and at least one mobile device 130 connected to the at least one wearable tracking device 110 to receive a location of the at least one wearable tracking device 110 based on a GPS signal, and perform at least one of emit an alarm sound and display an alarm warning thereon.

The at least one wearable tracking device 110 may include a tracking body 111 to send the GPS signal therefrom, a first strap 112 disposed at a first end on at least a portion of a first side of the tracking body 111, a second strap 113 disposed at a first end on at least a portion of a second side of the tracking body 111, a buckle 114 disposed on at least a portion of a second end of the first strap 112, and a connecting portion 115 disposed on at least a portion of a second end of the second strap 113 to detachably connect to the buckle 114.

The at least one wearable tracking device 110 may further include an RFID lock 116 disposed within at least a portion of the buckle 114 to prevent the connecting portion 115 from detaching from the buckle 114.

The tracking and alarm system 100 may further include at least one RFID reader 140 to connect to the RFID lock 116 to unbind the connecting portion 115 from the buckle 114, such that the buckle 114 and the connecting portion 115 are unlocked.

The tracking body 111 may determine at least one of a tamper of the buckle 114 and an attempted tamper of the buckle 114 in response to detecting at least one of the buckle 114 being moved away from and attempted to be moved away from the connecting portion 115, respectively.

The tracking body 111 may send at least one of an amber alert and a silver alert to the at least one primary receiver 120 and the at least one mobile device 130 in response to detecting at least one of a tamper of the buckle 114 and an attempted tamper of the buckle 114.

The at least one primary receiver 120 and the at least one mobile device 130 may emit the alarm sound in response to a tampering of the at least one wearable tracking device 110.

The at least one primary receiver 120 and the at least one mobile device 130 may display the alarm warning in response to an attempted tampering of the at least one wearable tracking device 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tracking and alarm system, comprising:
at least one wearable tracking device to be worn around at least a portion of a body of a user;
at least one primary receiver connected to the at least one wearable tracking device to receive a location of the at least one wearable tracking device based on a GPS signal, and perform at least one of emit an alarm sound and display an alarm warning thereon; and
at least one mobile device connected to the at least one wearable tracking device to receive a location of the at least one wearable tracking device based on a GPS signal, and perform at least one of emit an alarm sound and display an alarm warning thereon.

2. The tracking and alarm system of claim 1, wherein the at least one wearable tracking device comprises:
a tracking body to send the GPS signal therefrom;
a first strap disposed at a first end on at least a portion of a first side of the tracking body;
a second strap disposed at a first end on at least a portion of a second side of the tracking body;
a buckle disposed on at least a portion of a second end of the first strap; and
a connecting portion disposed on at least a portion of a second end of the second strap to detachably connect to the buckle.

3. The tracking and alarm system of claim 2, wherein the at least one wearable tracking device further comprises:
an RFID lock disposed within at least a portion of the buckle to prevent the connecting portion from detaching from the buckle.

4. The tracking and alarm system of claim 3, further comprising:
at least one RFID reader to connect to the RFID lock to unbind the connecting portion from the buckle, such that the buckle and the connecting portion are unlocked.

5. The tracking and alarm system of claim 2, wherein the tracking body determines at least one of a tamper of the buckle and an attempted tamper of the buckle in response to detecting at least one of the buckle being moved away from and attempted to be moved away from the connecting portion, respectively.

6. The tracking and alarm system of claim 2, wherein the tracking body sends at least one of an amber alert and a silver alert to the at least one primary receiver and the at least one mobile device in response to detecting at least one of a tamper of the buckle and an attempted tamper of the buckle.

7. The tracking and alarm system of claim 1, wherein the at least one primary receiver and the at least one mobile device emit the alarm sound in response to a tampering of the at least one wearable tracking device.

8. The tracking and alarm system of claim 1, wherein the at least one primary receiver and the at least one mobile device display the alarm warning in response to an attempted tampering of the at least one wearable tracking device.
